(19) United States
(12) Patent Application Publication
(10) Pub. No.: US 2010/0013839 A1
(43) Pub. Date: Jan. 21, 2010

(54) Integrated GPU, NIC and Compression Hardware for Hosted Graphics

(76) Inventor: Andrew R. Rawson, Austin, TX (US)

Correspondence Address: HAMILTON & TERRILE, LLP - AMD, P.O. BOX 203518, AUSTIN, TX, 78720, US

(21) Appl. No.: 12/176,946

(22) Filed: Jul. 21, 2008

(51) Int. Cl. G06T 1/20; G06F 13/14

(52) U.S. Cl. 345/502; 345/520

(57) ABSTRACT

A computer graphics processing system includes an integrated graphics and network hardware device having a PCI Express interface logic unit, a graphics processor unit, a graphics memory, a compression unit and a network interface unit, all connected together on a PCI Express adapter card using one or more dedicated communication interfaces so that data traffic for graphics processing and network communication need not be routed over a peripheral interface circuit which has a communications bandwidth that must be shared with other system components.

### BACKGROUND OF THE INVENTION

1. Field of the Invention

The present invention relates in general to the field of computing systems. In one aspect, the present invention relates to a method and system for hosting graphics processing at a centralized location for remote users.

2. Description of the Related Art

In general, computer system architectures are designed to provide the central processor unit(s) with high speed, high bandwidth access to selected system components (such as random access system memory (RAM)), while lower speed and bandwidth access is provided to other, lower priority components (such as the Network Interface Controller (NIC), graphics processing unit (GPU), super I/O controller, read only memory (ROM). For example, FIG. 1 illustrates an example architecture for a conventional computer system 100. The computer system 100 includes a processor 102 that is connected to a system memory 104 and a fast or “north” bridge 106, where the north bridge circuit 106 is connected over a high-speed, high-bandwidth bus (e.g., a PCI Express bus 107) to a GPU 108, and is also connected over a high-speed, high-bandwidth bus (e.g., an Alink bus) to a slow or “south” bridge 112. The “south” bridge 112 is connected to a Peripheral Component Interconnect (PCI) bus 110 (which in turn is connected to a network interface card (NIC) 124), a serial AT Attachment (SATA) interface 114, a universal serial bus (USB) interface 116, and a Low Pin Count (LPC) bus 118 (which in turn is connected to a super input/output controller chip (SuperI/O) 120 and BIOS memory 122). As will be appreciated, it will be appreciated that other buses, devices, and/or subsystems may be included in the computer system 100 as desired, such as caches, modems, parallel or serial interfaces, SCSI interfaces, etc. Also, the north bridge 106 and the south bridge 112 may be implemented with a single chip or a plurality of chips, leading to the collective term “chipset.”

As depicted, the processor 102 is coupled directly to the system memory 104, and is connected through the north bridge 106 as an interface to the GPU device 108 (e.g., over a PCI-e bus 107) and the south bridge circuit 112 (e.g., over an Alink bus). Thus, the north bridge 106 typically provides high speed communications between the CPU 102, GPU 108, and the south bridge 112. In turn, the south bridge 112 provides an interface between the north bridge 106 and various peripherals, devices, and subsystems coupled to the south bridge 112 via the PCI bus 110, SATA interface 114, USB interface 116, and the LPC bus 118. For example, the super I/O chip 120 and BIOS chip are coupled to the south bridge 112 via the LPC bus 118, while removable peripheral devices (e.g., NIC 124) are connected to the south bridge 112 via the PCI bus 110. Industry standard system design typically would connect the discrete GPU hardware 108 to the north bridge circuit 106 or on a peripheral interface port (either placed down on the motherboard or packaged in an add-in card), while the NIC 124 is placed off the south bridge 112 on a separate peripheral interface port packaged on a second add in card. The south bridge 112 also provides an interface between the PCI bus 110 and various devices and subsystems, such as a modem, a printer, keyboard, mouse, etc., which are generally coupled to the computer system 100 through the LPC bus 118, or one of its predecessors, such as an X-bus or an Industry Standard Architecture (ISA) bus. The south bridge 112 includes logic used to interface the devices to the rest of computer system 100 through the SATA interface 114, the USB interface 116, and the LPC bus 118.

With the conventional arrangement and connection of computer system resources, certain types of computing activities can overload the internal bandwidth capabilities between the CPU and connected devices, such as the GPU 108 and the NIC 124. For example, internal access to shared resources, such as the system memory 104, can be overloaded when the CPU 102 and a connected device (e.g., GPU 108) are both accessing the system memory 104 to transfer data to or from the memory 104. In addition, communications between connected devices, such as the GPU 108 and NIC 124, impose a large bandwidth burden on the peripheral interface which may result in data transfer bottlenecks for the computer system 100. In an example application where the computer system 100 provides a graphics hosting function for a plurality of remote clients, a display stream generated by the GPU 108 is typically transferred over the north bridge 106 to the system memory 104, and is then transferred back across the north bridge 106 and south bridge 112 to the NIC 124, which not only creates additional contention for the circuits along the transfer paths, but also adds delay as the data migrates across the relatively slow south bridge 112 and associated PCI bus 110. To avoid burdening the standard add-in card bulkhead area with the connectors and cables required to transfer these multiple compressed or uncompressed video data streams from the GPU 108 to the NIC 124, special internal add-in card peripheral interface cross-over cables could be used, but these are cumbersome and costly.

Therefore, there is a need for an improved computer system architecture, apparatus and operating methodology which reduces the contention on shared resources, especially with devices connected to the PCI bus that require short memory access latency and high data transfer bandwidths. In addition, there is a need for a computer system design and methodology which overcomes the problems in the art, such as outlined above. Further limitations and disadvantages of conventional processes and technologies will become apparent to one of skill in the art after reviewing the remainder of the present application with reference to the drawings and detailed description which follow.

### SUMMARY OF THE INVENTION

Broadly speaking, the present invention provides an integrated GPU, NIC and compression hardware device for use in hosting graphics processing at a central server location for use by a plurality of networked users. In selected embodiments, the GPU, compression unit, and network interface controller components are packaged together on a single printed circuit board which provides dedicated communication interfaces between the components rather than routing data traffic between these components over the PCI or PCI Express peripheral interface circuits which have a communications bandwidth that must be shared with other system components. By including point-to-point routing with short wiring runs on the integrated graphics processing card, the graphics processing, compression and communication functions can be quickly and efficiently performed without requiring data transfers across slow PCI or PCI-express bus interfaces or other interface controller circuits, such as north bridge or south bridge circuits. A single integrated GPU, NIC and compression unit also increases the graphics processing speed and simplifies the communications protocol for sending graphics to remote users since the graphics processing, compression and network interface circuits interact directly with one another over dedicated communication interfaces, thereby improving the remote user's computing experience. Another benefit from integrating the GPU, NIC and compression unit functions on a single integrated card is that there is more bandwidth available in the computer system. In addition, system costs are lowered by reducing the processing functions of two or more cards onto a single card. The increased graphics processing and network interface speeds provided by an integrated GPU, NIC and compression hardware device enables more graphics streams to be processed at a central location and multiplexed over a communication network to different remote users. In the multi-user network configuration, the central or host server uses the integrated graphics processing card to perform graphics processing for the computing experience of one more remote users computing experiences, and to deliver the experience to the remote user (e.g., at the client or local machine or terminal) over a communication link (e.g., a dedicated cabling or a TCP/IP network).

In accordance with various embodiments of the present invention, a method and apparatus provide a computer graphics processing system. In an exemplary embodiment, the computer graphics processing system includes a central processor unit with one or processor cores, a system memory, and a high speed system controller coupled to the CPU and system memory. In addition, an integrated graphics and network hardware device is coupled over a PCI Express bus to the high speed system controller, and includes one or more GPUs, a graphics memory, one or more compression units, and a network interface unit. The integrated graphics and network hardware device may also include a PCI Express interface logic unit connected to the one or more GPUs for managing data communications over the PCI Express bus to the high speed system controller. By forming the integrated graphics and network hardware device on PCI Express adapter card, the GPU, graphics memory, compression unit and network interface unit may be connected together over one or more dedicated communication interfaces, thereby avoiding the need to route data traffic over the high speed system controller during graphics processing. In selected embodiments, the GPU is implemented with hardware circuitry for rendering digital image information for one or more video data streams in response to one or more graphics command lists stored in the graphics memory by the CPU and then storing the rendered digital image information in the graphics memory. In selected embodiments, multiple GPUs may be used so that each GPU runs a virtual machine that renders digital image information for a video data stream. Alternatively, a single GPU may run multiple virtual machines, where each virtual machine renders digital image information for a video data stream. The compression unit may also be implemented with hardware circuitry for performing video compression on any digital image information rendered by the graphics processor unit and stored in the graphics memory. In addition, the network interface unit may be implemented with hardware circuitry for transmitting compressed digital image information video over a computer network using a predetermined communication protocol.

In other embodiments, a method and apparatus are provided for hosting graphics processing at a central server on an integrated graphics processing card. In operation, the integrated graphics processing card obtains configuration data from a host processor, where the configuration data includes one or more graphics command lists that may be stored in the system memory or a graphics storage device included on the integrated graphics processing card. The integrated graphics processing card then performs graphics processing with one or more GPUs included on the integrated graphics processing card to produce one or more video data streams by rendering digital image information in response to the one or more graphics command lists. The resulting video data streams may be stored in a graphics storage device included on the integrated graphics processing card. The integrated graphics processing card then compresses the video data stream(s) (e.g., by performing MPEG or WMV9 video compression) with a compression unit included on the integrated graphics processing card to produce one or more compressed video data streams. The resulting compressed video data streams may be stored in the graphics storage device included on the integrated graphics processing card and/or may be transferred from the compression unit to the network interface unit over a dedicated communication interface included on the integrated graphics processing card. Finally, the integrated graphics processing card transmits the compressed video data stream(s) over a network using a network interface unit included on the integrated graphics processing card.

In yet other embodiments, a hosted graphics system and methodology are provided for using an integrated graphics processing card to performing graphics processing for a plurality of remote client devices. The disclosed integrated graphics processing card includes a graphics processor unit for generating one or more video data streams, a hardware compression unit coupled to receive the one or more video data streams generated by the graphics processing unit and to generate one or more compressed video data streams, and a network interface controller unit coupled to receive the one or more compressed video data streams generated by the hardware compression unit and to transmit the one or more compressed video data streams to a remote client device over a communication network using a predetermined communication protocol. The integrated graphics processing card may also include a PCI Express interface logic unit connected to the graphics processor unit for managing data communications over a PCI Express bus to a host processor. In addition, a graphic memory may be included in the integrated graphics processing card for storing one or more graphics command lists, one or more video data streams or one or more compressed video data streams.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a simplified architectural block diagram of a conventional computer system.

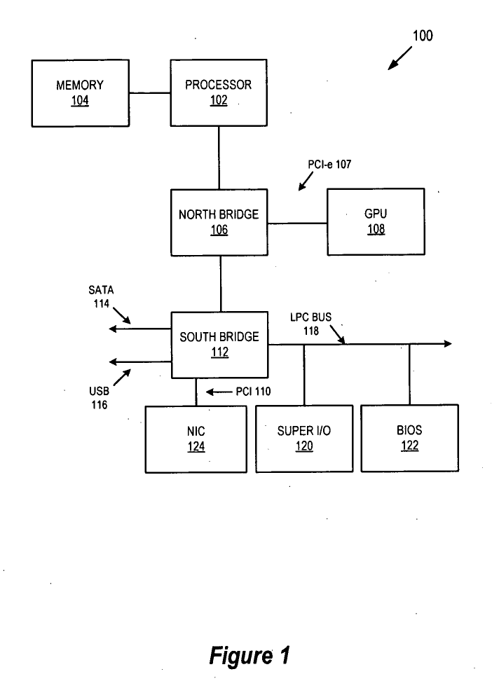

FIG. 2 illustrates a simplified architectural block diagram of a computer system having an integrated GPU, NIC and compression hardware device in accordance with selected embodiments of the present invention.

FIG. 3 illustrates a graphics hosting server which includes an integrated graphics hardware device which performs graphics processing for one or more networked users.

FIG. 4 depicts an exemplary flow methodology for performing graphics processing and transmission on multiple data streams using an integrated graphics processing device.

### DETAILED DESCRIPTION

A method and apparatus are provided for integrating graphics processing, compression and network protocol interface components onto a single printed circuit board or card which provides dedicated communication interfaces between the components. In selected embodiments, an integrated graphics processing card is constructed to include one or more graphics processor units, each of which is coupled in series with a compression unit and a network interface controller unit. In addition, a graphics memory may be included on the integrated graphics processing card for accelerating graphics processing by storing command list instructions from the CPU, as well as uncompressed graphics data generated by the GPU, and compressed graphics data generated by the compression unit. Finally, the integrated graphics processing card includes a PCI Express interface logic unit connected to each GPU for managing data communications over a PCI Express bus to a high speed north bridge circuit. In selected embodiments, the integrated graphics processing card is used at a central graphics server to supply different video data streams to N thin client devices by generating, compressing and multiplexing multiple streams of high resolution display data and/or audio data onto a single high speed digital communication network. In operation, one or more CPUs at the central graphics server issue command list instructions for each of the N video data streams to the integrated graphics processing card for storage in the graphics memory. The GPU can access the command lists from system memory, or can directly access the command lists from the graphics memory, thereby avoiding the need to send a data request across a low bandwidth PCI bus or south bridge circuit if the GPU is connected to a slower speed peripheral interface bus. Based on the command lists, the GPU generates uncompressed image data for each data stream which is then locally stored or buffered back in the graphics memory, again without having to send the data across a low bandwidth PCI bus or south bridge circuit. However, given the connection of the integrated graphics processing card to the high speed PCI Express bus and north bridge circuit, the uncompressed image data may in selected embodiments be stored in the system memory without exacting a large delay penalty. Wherever stored, the compression unit retrieves the uncompressed image data for each data stream and compresses the data (e.g., by performing audio and/or video compression), all without having to send the data across a low bandwidth PCI bus or south bridge circuit. The compressed audio/video data is then provided to the NIC where each data stream is configured and multiplexed onto a single high speed digital communication network for transmission to the remote thin clients.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

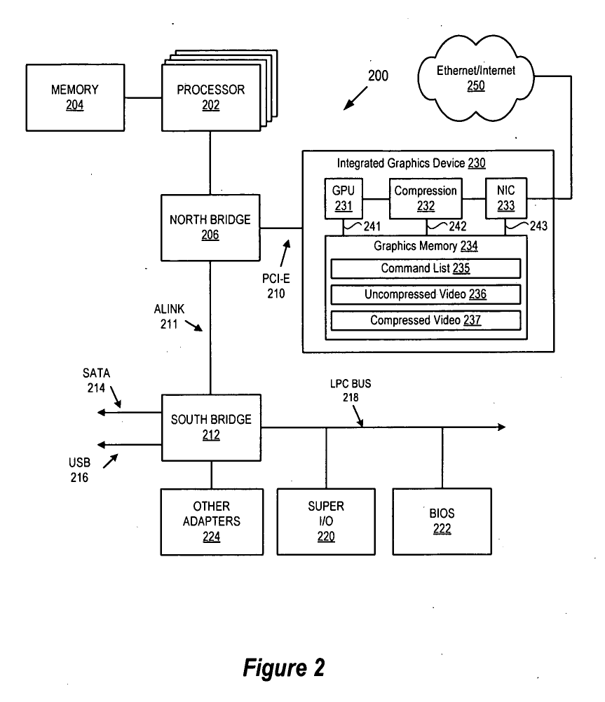

Turning now to FIG. 2, there is depicted a simplified architectural block diagram of a computer system 200 having an integrated GPU, NIC and compression hardware device 230 in accordance with selected embodiments of the present invention. The depicted computer system 200 includes one or more processors or processor cores 202, a north bridge 206, memory 204, an integrated graphics device 230, a PCI Express (PCI-E) bus 210, an Alink bus 211, a south bridge 212, a serial AT Attachment (SATA) interface 214, a USB interface 216, an LPC bus 218, an super input/output controller chip 220, an BIOS memory 222 and one or more other adapters 224. As will be appreciated, other buses, devices, and/or subsystems may be included in the computer system 200 as desired, e.g. caches, modems, parallel or serial interfaces, SCSI interfaces, etc. In addition, the computer system 200 is shown as including both a north bridge 206 and a south bridge 212, but the north bridge 206 and the south bridge 212 may be implemented with only a single chip or a plurality of chips in the “chipset,” or may be replaced by a single north bridge circuit.

By coupling the processor 202 to the north bridge 206, the north bridge 206 provides an interface between the processor 202 and the memory 204 to the integrated graphics device 230 (over the PCI-e bus 210) and the south bridge 212 (over the Alink bus 211). The south bridge 212 provides an interface between the Alink bus 211 and the peripherals, devices, and subsystems coupled to the SATA interface 214, the USB interface 216, and the LPC bus 218. The Super I/O chip 220 and BIOS 222 are coupled to the LPC bus 218, while other adapters 224 are connected to the south bridge 212 (e.g., over a PCI bus).

The north bridge 206 provides communications access between and/or among the processor 202 and memory 204, the integrated graphics device 230 (and PCI-E bus 210), and devices coupled to the Alink bus 211 through the south bridge 212. In addition, removable peripheral devices may be inserted into PCI slots (not shown) connected to the South Bridge 212. The south bridge 212 also provides an interface by which various devices and subsystems, such as a modem, a printer, keyboard, mouse, etc., which are generally coupled to the computer system 200 through the LPC bus 218 (or its predecessors, such as the X-bus or the ISA bus). The south bridge 212 includes logic used to interface the devices to the rest of computer system 200 through the SATA interface 214, the USB interface 216, and the LPC bus 218.

The computer system 200 may be part of central server which hosts data and applications for use by one or more remote client devices. For example, the central host server may host a centralized graphics solution which supplies one or more video data streams for display at remote users (e.g. a laptop, PDA, etc.) to provide a remote PC experience. To this end, the integrated graphics device 230 is attached to the processor(s) 202 over a high speed, high bandwidth PCI-Express bus 210, and includes one or more GPUs 231, a data compression unit 232 and a network interface unit 233 all packaged together on a single industry standard or non-standard add-in card. In operation, the GPU 231 generates computer graphics in response to software executing on the processor(s) 202. In particular, the software may create data structures or command lists representing the objects to be displayed. Rather than storing the command lists in the system memory 204, the command lists 235 may be stored in the graphics memory 234 where they may be quickly read and processed by the GPU 231 to generate pixel data for the display. The processing by the GPU 231 of the data structures to represent objects to be displayed and the generation of the image data (e.g. pixel data) is referred to as rendering the image. The command list/data structures 235 may be defined in any desired fashion to include a display list of the objects to be displayed (e.g., shapes to be drawn into the image), the depth of each object in the image, textures to be applied to the objects in various texture maps, etc. For any given data stream, the GPU 231 may be idle a relatively large percentage of the time that the system 200 is in operation (e.g. on the order of 90%), but this idle time may be exploited to render image data for additional data streams without impairing the overall performance of the system 200. The GPU 231 may write the pixel data as uncompressed video to a frame buffer 236 in the graphics memory 234 by generating write commands which are transmitted over a dedicated communication interface 241 to the graphics memory 234. However, given the high-speed connection configuration, the GPU 231 may instead write the uncompressed video data to the system memory 204 without incurring a significant time penalty. Thus, the frame buffer 236 may store uncompressed video data for one or more data streams to be transmitted to a remote user.

Wherever stored, one or more audio and/or video compression techniques may be applied to the uncompressed video data. Any of a variety of video compression techniques can be implemented at the compression unit 232, such as intraframe compression and interframe compression which operate to compress video information by reducing both spatial and temporal redundancy that is present in video frames. To implement data compression, the integrated graphics device 230 includes a compression unit 232 which provides dedicated hardware and/or software for performing intraframe compression, interframe compression, such as by performing spatial or block-based encoding using a discrete cosine transform (DCT) coding scheme, quantization, run-level encoding, variable length coding or using other entropy encoding technique, such as a Context-based Adaptive Binary Arithmetic Coding (CABAC), Context Adaptive Variable Length Coding (CAVLC) and the like. In operation, the compression unit 232 retrieves the uncompressed video 236 from the graphics memory 234 by generating read commands which are transmitted over a dedicated communication interface 242 to the graphics memory 234. The retrieved data is then compressed at the compression unit 232 to reduce the quantity of data used to represent audio/video information. The compression unit 232 may then write the compressed video data over the dedicated communication interface 242 to a buffer 237 in the graphics memory 234, though the compressed video data may instead be stored in the system memory 204. Thus, the buffer 237 may store compressed video data for one or more data streams to be transmitted to a remote user.

To deliver the compressed video data stream(s) to the remote users, the integrated graphics device 230 includes a network interface controller (NIC) device 233. The NIC 233 (also referred to as a network card, network adapter, LAN Adapter or network interface card) is a dedicated hardware circuit that is designed to allow computers to communicate over a computer network 250 using a predetermined communication protocol. The NIC 233 includes hardware circuitry which is provided to receive and transmit signals to and from a communication network 250 (e.g., the Internet or another computer network) using a predetermined communication protocol, such as TCP/IP, thereby allowing the computer system 200 to connect to remote users/client devices (not shown). In operation, the NIC 233 retrieves the compressed video 237 from the graphics memory 234 by generating read commands which are transmitted over a dedicated communication interface 243 to the graphics memory 234. The retrieved data is then processed at the NIC 233 to produce an outbound video data stream that is formatted in accordance with a particular network communication standard. The NIC 233 may also process the outbound data stream(s) in accordance with a remote display protocol, such as RDP, ICA, VNC, RGS or other proprietary schemes.

By connecting the GPU 231, compression unit 232 and NIC 233 components in the integrated graphics device 230 to the graphics memory 234 with dedicated communication interfaces, there is no need to read or write data over the Alink bus 211 and south bridge circuit 212, thereby freeing the other resources in the computer system 200 for other operations. In addition, the connection of the integrated graphics device 230 over the high speed PCI-E bus 210 allows software control of the video processing to proceed expeditiously as compared to conventional configurations where the GPU is connected to the south bridge. In addition to reducing contention problems in the computer system 200, the integrated graphics device 230 increases the overall processing speed for rendering, compressing and transmitting graphics information, which not only improves the remote experience, but allows more remote users to be supported by a single host computer system.

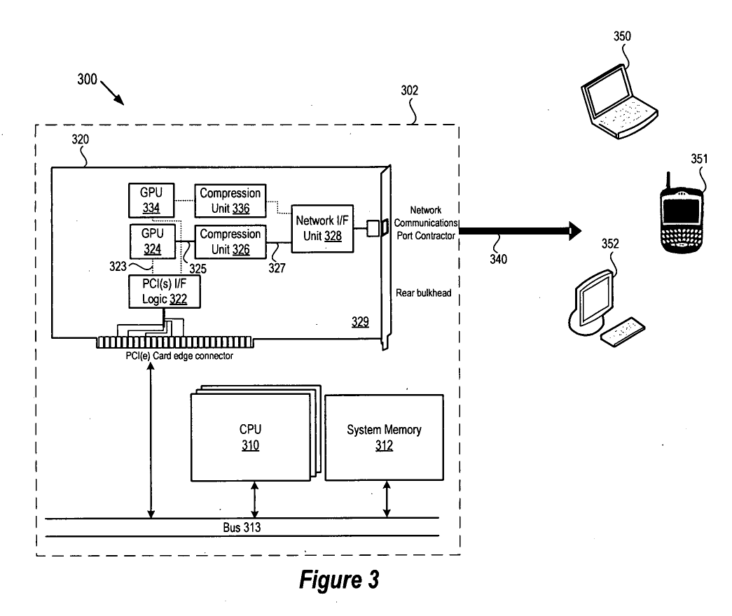

An example of such a multi-user application is illustrated in FIG. 3 which depicts a hosted graphics system 300 which uses a graphics hosting server 302 to perform graphics processing for one or more networked users 350-352. The graphics hosting server 302 includes one or more central processing units (CPU) 310, system memory 312, a system bus 313, and integrated graphics hardware device 320 which performs graphics processing for one or more networked users 350-352. The CPU 310 may be implemented with one or more processor cores that implement the AMD64 instruction set architecture, or any other desired instruction set architecture, including but not limited to the x86 ISA, the PowerPC ISA, the ARM ISA, the SPARC ISA, the MIPS ISA, etc. In some embodiments, only one processor core may be included. In other embodiments, two or more processor cores may be included in a multi-core configuration. As for the system memory 312, it may be connected through a controller, and may be implemented as on-board or off-chip primary (L1), secondary (L2) and/or tertiary (L3) cache memory, DDR SDRAM module(s), Flash, RAM, ROM, PROM, EPROM, EEPROM, disk drive memory devices, and the like. The CPU 310 and system memory 312 are connected to one another over a high speed, high bandwidth bus or interface 313 (e.g., a HyperTransport interconnect), which in turn is connected to the integrated graphics hardware device 320. The bus 313 serves as a bridge, interface and/or communication bus that is responsible for communicating between the CPU 310, the system memory 312 and the integrated graphics hardware device 320. Thus, the bus 313 may incorporate memory controller functionality to control the system memory 313. The bus 313 may also include a north bridge unit, which may be a single integrated circuit chip, two or more chips in a multi-chip module, two or more discrete integrated circuits coupled to a circuit board, etc. The depicted integrated graphics hardware device 320 includes a PCI Express interface logic unit component 322, one or more GPU components 324, 334, one or more compression unit components 326, 336, and a network interface unit component 328, where all of the components are packaged on a single, industry standard add-in card 329, such as a PCI or PCI-Express adapter. Though not shown, the integrated graphics hardware device 320 may also include a graphics memory or buffer which is used to hold command lists and to process and/or compress video data for transmission to the networked users 350-352. However, for clarity and ease of understanding, not all of the elements making up the graphics hosting server 302 are described in detail. Such details are well known to those of ordinary skill in the art, and may vary based on the particular computer vendor and microprocessor type. Moreover, the graphics hosting server 302 may include other buses, devices, and/or subsystems, depending on the implementation desired. Finally, it will be appreciated that other packaging schemes are possible. For example, the compression unit(s) 236, 336 may be integrated into the GPUs 324, 334, or alternatively combined with the network interface unit 328.

By placing the GPU(s) 324, compression unit(s) 326, and network interface unit 328 on the same physical printed circuit board 329, they may be connected together using dedicated communication interfaces. For example, the PCI Express interface logic unit component 322 manages data communications over the bus 313, and is connected to the GPU(s) 324 over a dedicated communication interface 323. The GPU 324 is in turn connected to the compression unit 326 over a dedicated communication interface 325, and the compression unit 326 is connected to the NIC unit 328 over a dedicated communication interface 327. With these dedicated communication interfaces, the GPU, compression, and network interface components are able to route data traffic within the integrated graphics hardware device 320 rather than routing data traffic over the PCI of PCI Express peripheral interface 313 or other bus circuits (e.g., south bridge circuit) which must share its communications bandwidth with other system components. This performance advantage is increased by including a dedicated graphics memory on the integrated graphics hardware device 320 that is connected to the GPU, compression, and network interface components over point to point routing and short wiring runs. The point to point routing and short wiring runs on the card 320 not only increase the data processing speed for the card 320, but also increase the available bandwidth on the bus 313 for communication and simplifies the communication protocol.

With the integrated graphics hardware device 320, the graphics hosting server 302 may be configured to deliver a remote PC experience to one or more remote users 350-352 by creating and rendering each user's computing experience at the graphics hosting server 302. In operation, the graphics hosting server 302 performs all of the graphics processing for the remote user(s) 350-352. The graphics processing experience (inputs, outputs) for each remote user is delivered to the remote user at the client, local machine/terminal over a medium 340 (such as dedicated cabling or a network) using a remote display protocol (e.g., RDP, ICA, VNC, RGS and other proprietary schemes). The remote experience consists of providing pertinent input and output functions for the graphics hosting server 302 at the client (e.g., 350). Such input and output functions may include the display of the host's output to a local screen or screens, keyboard and mouse input from the client machine sent to the host, audio input and output from/to the user at the client machine sent to/from the host, and general purpose I/O, such as serial or parallel ports, but more typically USB ports.

Because of the efficiencies and performance improvements provided by the integrated graphics hardware device 320, the graphics hosting server 302 is able to drive more than one client (i.e. more than one end-user's computing experience) at a time. This solution is referred to as “1-to-N” (or 1:N) solution where the graphics hosting server 302 supplies the video data streams to N graphically rich, thin clients. The 1:N solution requires that the graphics hosting server 302 generate and multiplex multiple streams of high resolution display data onto a single high speed digital communication network (e.g., Ethernet). A variety of techniques can be used to generate multiple streams from the integrated graphics hardware device 320. For example, the integrated graphics hardware device 320 could include multiple physical GPUs 324, 334, where each GPU runs a virtual machine (VM). Alternatively, multiple virtual machines (VMs) can be configured to run on a single GPU 324 by instantiating true virtualization of GPU(s) across VMs, allowing it/them to be shared across among the machines. However generated, the virtual data streams must then be separately compressed using one or more compression engine(s) 326, 336, and then formatted by the transmission engine 328 for transmission to the remote clients for display.

The memory access and data transfer requirements for providing a 1:N solution would overwhelm the bandwidth capabilities of a conventionally designed computer system which places discrete GPU hardware on one peripheral interface port and a NIC hardware on a separate peripheral interface port, thereby creating data transfer bottlenecks for the system. However, by integrating the GPU 324, compression hardware 326 and network interface card 328 onto the same printed circuit board 329 along with a graphics memory or buffer, the GPU 324, compression unit 326 and NIC 328 are able to generate, compress and transmit multiple display streams without imposing a large bandwidth burden on the rest of the system 302.

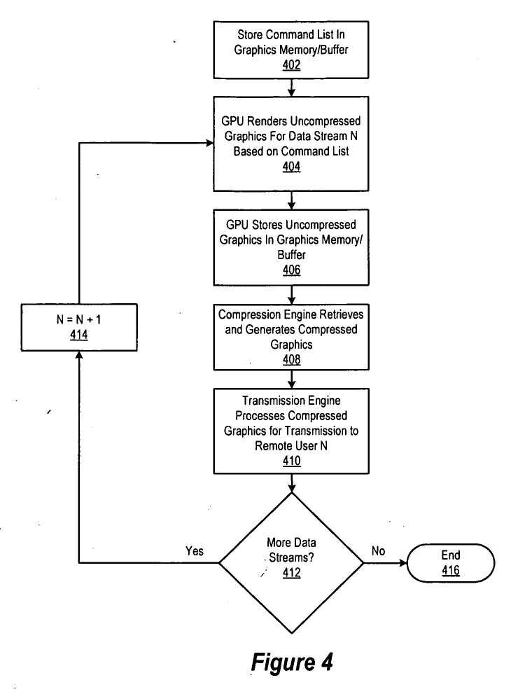

Turning now to FIG. 4, an exemplary method is illustrated for performing graphics processing and transmission on multiple data streams using an integrated graphics processing device. The method begins at step 402 where a command list is stored by the host processor in the graphics memory or buffer. Preferably, the graphics memory or buffer is located in the integrated graphics processing device, but it may be located in the system memory. At step 404, the GPU retrieves the command list, and uses the command list to render uncompressed graphics for a given data stream N. The resulting uncompressed graphics for the data stream are then stored in the graphics memory/buffer at step 406. At step 408, the compression engine retrieves the uncompressed graphics, and generates therefrom compressed graphics using any of a variety of audio and/or video compression techniques. For example, video data can be compressed by applying image compression and/or motion compensation to compress video information by reducing both spatial and temporal redundancy that is present in video frames. However, it will be appreciated that a number of compression standards have been developed or are under development for compressing and decompressing video information, such as the Moving Pictures Expert Group (MPEG) standards for video encoding and decoding (e.g., MPEG-1, MPEG-2, MPEG-3, MPEG-4, MPEG-7, MPEG-21) or the Windows Media Video compression standards (e.g., WMV9). The compressed graphics may be stored in the graphics memory/buffer or forwarded directly to the transmission engine (step 410) where they are processed for transmission to the remote user N. If there are additional data streams to be processed (affirmative outcome to decision 412), the next data stream is selected (step 414), and the process is repeated until there are no additional data streams to be processed (negative outcome to decision 412), at which point the process ends.

As described herein, selected aspects of the invention as disclosed above may be implemented in hardware or software. Thus, some portions of the detailed descriptions herein are consequently presented in terms of a hardware-implemented process and some portions of the detailed descriptions herein are consequently presented in terms of a software-implemented process involving symbolic representations of operations on data bits within a memory of a computing system or computing device. Generally speaking, computer hardware is the physical part of a computer, including its digital circuitry, as distinguished from the computer software that executes within the hardware. The hardware of a computer is infrequently changed, in comparison with software and hardware data, which are “soft” in the sense that they are readily created, modified or erased on the computer. These descriptions and representations are the means used by those in the art to convey most effectively the substance of their work to others skilled in the art using both hardware and software.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A computer graphics processing system comprising:
a central processor unit (CPU) comprising at least one processor core;
a system memory;
a high speed system controller coupled to the CPU and system memory; and
an integrated graphics and network hardware device coupled over a PCI Express bus to the high speed system controller, the integrated graphics and network hardware device comprising a graphics processor unit, a graphics memory, a compression unit and a network interface unit.

2. The computer graphics processing system of claim 1, where the integrated graphics and network hardware device comprises PCI Express adapter card on which the graphics processor unit, graphics memory, compression unit and network interface unit are connected together over one or more dedicated communication interfaces.

3. The computer graphics processing system of claim 1, where the graphics processor unit comprises hardware circuitry for rendering digital image information in response to a graphics command stored in the graphics memory by the CPU and then storing the rendered digital image information in the graphics memory.

4. The computer graphics processing system of claim 1, where the graphics processor unit comprises hardware circuitry for rendering digital image information for a plurality of video data streams in response to a corresponding plurality of graphics commands stored in the graphics memory by the CPU.

5. The computer graphics processing system of claim 1, where the compression unit comprises hardware circuitry for performing video compression on any digital image information rendered by the graphics processor unit and stored in the graphics memory.

6. The computer graphics processing system of claim 1, where the network interface unit comprises hardware circuitry for transmitting compressed digital image information video over a computer network using a predetermined communication protocol.

7. The computer graphics processing system of claim 1, where the integrated graphics and network hardware device comprises a plurality of graphics processor units, where each graphics processor unit runs a virtual machine that renders digital image information for a video data stream.

8. The computer graphics processing system of claim 1, where the integrated graphics and network hardware device comprises a graphics processor unit which runs a plurality of virtual machines, where each virtual machine renders digital image information for a video data stream.

9. The computer graphics processing system of claim 1, where the integrated graphics and network hardware device comprises a PCI Express interface logic unit connected to the graphics processor unit for managing data communications over the PCI Express bus to the high speed system controller.

10. A method for hosting graphics processing at a central server on an integrated graphics processing card, comprising:
obtaining configuration data from a host processor, said configuration data comprising one or more graphics command lists;
performing graphics processing with a graphics processor unit included on an integrated graphics processing card to produce one or more video data streams in response to the one or more graphics command lists;
compressing the one or more video data streams with a compression unit included on the integrated graphics processing card to produce one or more compressed video data streams; and
transmitting the one or more compressed video data streams over a network using a network interface unit included on the integrated graphics processing card.

11. The method of claim 10, where performing graphics processing comprises rendering digital image information for one or more video data streams in response to the one or more graphics command lists stored in a graphics storage device included on the integrated graphics processing card.

12. The method of claim 10, where performing graphics processing comprises rendering digital image information for one or more video data streams in response to the one or more graphics command lists stored in a system memory.

13. The method of claim 10, where compressing the one or more video data streams comprises performing MPEG or WMV9 video compression on the one or more video data streams produced by the graphics processor unit.

14. The method of claim 10, further comprising storing the one or more video data streams in a graphics storage device included on the integrated graphics processing card.

15. The method of claim 10, further comprising storing the one or more compressed video data streams in a graphics storage device included on the integrated graphics processing card.

16. The method of claim 10, where performing graphics processing comprises performing graphics processing with a plurality of graphics processor units included on the integrated graphics processing card to produce one or more video data streams in response to the one or more graphics command lists.

17. The method of claim 10, further comprising transferring the one or more compressed video data streams from the compression unit to the network interface unit over a dedicated communication interface included on the integrated graphics processing card.

18. A hosted graphics system, comprising:
an integrated graphics processing card for performing graphics processing for a plurality of remote client devices, the integrated graphics processing card comprising:
a graphics processor unit for generating one or more video data streams,
a hardware compression unit coupled to receive the one or more video data streams generated by the graphics processing unit and to generate one or more compressed video data streams; and
a network interface controller unit coupled to receive the one or more compressed video data streams generated by the hardware compression unit and to transmit the one or more compressed video data streams to a remote client device over a communication network using a predetermined communication protocol.

19. The hosted graphics system of claim 18, where the integrated graphics processing card further comprises a PCI Express interface logic unit connected to the graphics processor unit for managing data communications over a PCI Express bus to a host processor.

20. The hosted graphics system of claim 18, where the integrated graphics processing card further comprises a graphics memory for storing one or more graphics command lists, one or more video data streams or one or more compressed video data streams.
